(19) United States
(12) Patent Application Publication
(10) Pub. No.: US 2011/0210013 A1
(43) Pub. Date: Sep. 1, 2011

(54) SELECTIVE GAS SENSOR DEVICE AND ASSOCIATED METHOD

(75) Inventors: Vidya Ramaswamy, Niskayuna, NY (US); James Anthony Ruud, Delmar, NY (US); Mohan Manoharan, Bangalore (IN); Todd-Michael Striker, Ballston Lake, NY (US); Patrick Daniel Willson, Latham, NY (US)

(73) Assignee: GENERAL ELECTRIC COMPANY, SCHENECTADY, NY (US)

(21) Appl. No.: 12/713,481

(22) Filed: Feb. 26, 2010

(51) Int. Cl. G01N 27/26

(52) U.S. Cl. 205/775; 204/406

(57) ABSTRACT

A detection system is presented. The detection system includes a sensing component and a data analyzer. The sensing component includes a first sensor and a second sensor in fluid communication with the first sensor. The first sensor is disposed to allow operation at a predetermined temperature T₁ and is selective to a first gas species at T₁ and in presence of a second gas species. The second sensor is disposed to allow operation at a temperature T₂ and is sensitive to the first gas species and a second gas species at T₂. Temperature T₂ is lower than T₁. The data analyzer is disposed to receive an output signal from the sensing component and configured to calculate concentrations of the first gas species and the second gas species based on the output signal from the sensing component. A method of calculating concentrations of gas species in a gaseous mixture is also presented.

This invention was made with Government support under contract number DE-FG36-06G016053 awarded by U.S. Department of Energy. The Government has certain rights in the invention.

### BACKGROUND

The invention relates generally to a sensor for detecting gases in an exhaust stream generated from combustion. More particularly, the invention relates to a sensor for selectively determining the concentrations of gases such as NOx, CO of combustion byproducts.

Exhaust gas streams generally contain nitrogen oxides (NOx), unburned hydrocarbons (HC), and carbon monoxide (CO). It may be sometimes desirable to control and/or reduce the amount of one or more of the exhaust gas stream constituents. The individual concentrations of the constituent gases may be used as parameters to optimize the combustion characteristics of internal combustion engines, coal boiler, gas turbines etc. Measurement and control of the concentrations of these individual constituents of exhaust gases may result in improved combustion efficiency and emission controls. In some cases, the concentration of one gas may influence or control the measurement of the concentration of another gas. In those instances, measurement of the concentration of each constituent gas is desirable.

Solid-state potentiometeric gas sensors are often used as exhaust gas sensors for emission control in combustion exhausts. These sensors are sensitive to parts per million (ppm) levels of NOₓ, CO, and hydrocarbons. However, the selectivity of the sensors is often inadequate. Many sensors cannot distinguish between the two NO components NO and NO₂. The selectivity and sensitivity of the sensors are improved by using various electrode and electrolyte materials. Most of these sensors are sensitive to either NO₂ or NO.

Various approaches have been attempted to determine concentrations of individual gases in a mixture of gases. One approach is using a single pair of electrodes for detecting NO concentration in an NO containing gas and detecting NO₂ in an NO₂ containing gas, described in articles: B. M. Blackburn et. al “MultiFunctional Potentiometric Gas Sensor Array with an Integrated Heater and Temperature Sensors,” Advances in Electronic Ceramics: Ceramic Engineering and Science Proceedings, C. Randall, Editor, PV 28, Issue 8, 2007; and B. M. Blackburn et al, “Multifunctional Gas Sensor Array with Improved Selectivity Through Local Thermal Modification,” ECS Transactions, 11 (33)141-153, 2008. However, this approach does not determine individual concentrations of NO and NO₂ simultaneously in a mixed gas of NO and NO₂.

Another approach is the use of catalytic stages to convert exhaust gas to a conditioned gas, wherein NO and NO₂ components of the conditioned gas are in steady state equilibrium [U.S. Pat. No. 7,217,355 B2]. Two sensors are used to determine total NOₓ and O₂ concentration of the conditioned gas, independently [U.S. Pat. No. 7,611,612 B2]. However, use of catalytic filtering stages complicates the device design and can be difficult to manufacture. In addition, the device relies on multiple catalytic and absorbent materials, each specific to exhaust gas components at defined temperatures, further complicating the design and operation.

Thus, there is a need to provide an improved and alternate configuration of a sensor for detecting gases in exhaust stream. It would be further desirable that the sensor should selectively determine the concentrations of the gases such as NO, NO₂, CO etc.

### BRIEF DESCRIPTION

In one embodiment, a detection system is disclosed. The detection system includes a sensing component and a data analyzer. The sensing component includes a first sensor and a second sensor wherein the second sensor is in fluid communication with the first sensor. The first sensor is disposed to allow operation at a predetermined temperature T₁ and is selective to a first gas species in presence of a second gas species at T₁. The second sensor is disposed to allow operation at a temperature T₂ and is sensitive to the first gas species and a second gas species at T₂. Temperature T₂ is lower than T₁. The data analyzer is disposed to receive an output signal from the sensing component and configured to calculate concentrations of the first gas species and the second gas species based on the output signal from the sensing component.

Another embodiment is a method for calculating concentrations of gas species in combustion gas. The method includes the steps of providing and exposing a detection system to a gaseous mixture comprising a first gas species and a second gas species. The detection system includes a sensing component and a data analyzer. The sensing component includes a first sensor and a second sensor. The method further includes the step of maintaining the first sensor at a temperature T₁ and maintaining the second sensor at a temperature T₂, wherein T₂<T₁. The first sensor is selective to the first gas species in presence of the second gas species at T₁ and the second sensor is sensitive to the first gas species and a second gas species at T₂. Moreover, the method includes steps of transmitting an output signal from the sensing component to a data analyzer and calculating the concentration of the first gas species and the second gas species based on the output signal.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of the present invention.

FIG. 2 is a schematic representation of an electrochemical sensor in one embodiment of the present invention.

FIG. 3 is a schematic representation of an electrochemical sensor in one embodiment of the present invention.

FIG. 4 shows graphs of electromotive force (EMF) output of an electrochemical sensor as a function of NO₂ concentration at different temperatures, according to an embodiment of the present invention.

FIG. 5 shows graphs of electromotive force (EMF) output of an electrochemical sensor as a function of NO₂ concentration at different temperatures, according to another embodiment of the present invention.

FIG. 6 is a schematic representation of a detection system according to an exemplary embodiment of the present invention.

### DETAILED DESCRIPTION

As discussed in detail below, embodiments of the present invention disclose a detection system for detecting exhaust gases. The detection system is capable of determining concentrations of individual gases. Moreover, the invention will be described with respect to detecting NOx gases. However, one skilled in the art will further appreciate that, with simple modification, the invention is equally applicable for detection of other species.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and the claims that follow, the singular forms “a”, “an” and “the” include plural referents unless the context clearly dictates otherwise.

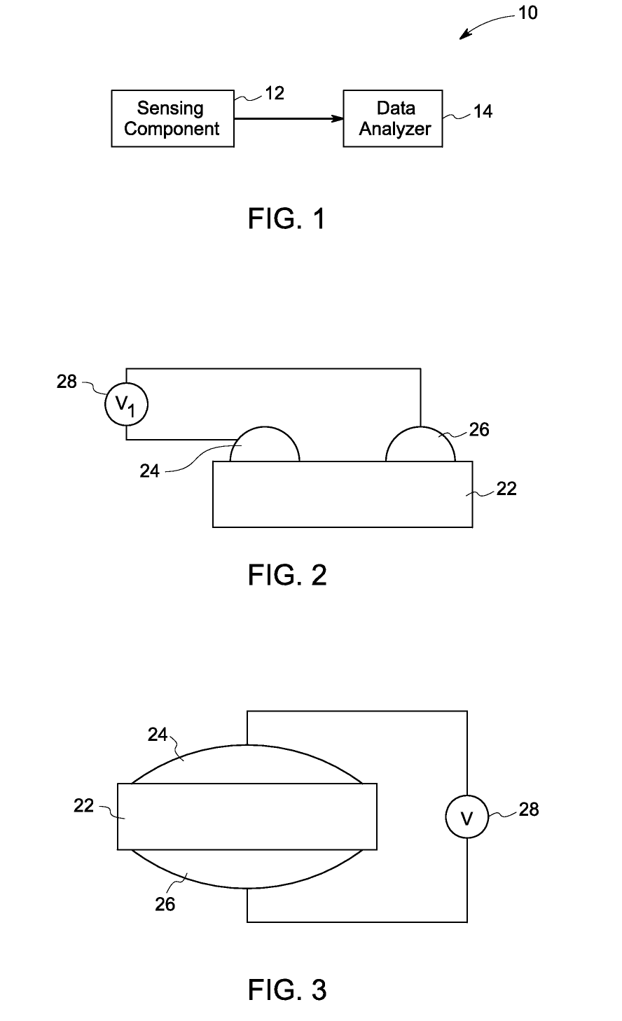

Embodiments of the invention described herein address the noted shortcomings of the state of the art. A detection system 10, according to an embodiment of the invention, is illustrated as shown in FIG. 1 for measuring exhaust gases. The detection system 10 has a sensing component 12 and a data analyzer 14. The sensing component 12 has two sensors—a first sensor and a second sensor. The first sensor and the second sensor are in fluid communication with each other which means both sensors are disposed relative to each other so that they contact the same ambient environment (i.e., are not hermetically separated from each other). Each of the first sensor and the second sensor is an electrochemical (potentiometric) gas sensor with sufficient sensitivity for exhaust gases to be useful for practical measurement.

As used herein, the term “sensitivity” determines the level of response of a sensor to a target for example a gas species. Sensitivity is a measure of a change in an output signal of a sensor with the change of a measured property, such as concentration of a gas species.

Electrochemical gas sensors measure the concentration of a target gas by oxidizing or reducing the target gas at an electrode and measuring the resultant electrical response. Typically the electrical response is voltage, but can also be current and resistance. While electrochemical sensors offer many advantages, they are not suitable for every gas. Since the detection mechanism involves the oxidation or reduction of the gas, electrochemical sensors are usually only suitable for gases that are electrochemically active, though it is possible to detect electrochemically inert gases indirectly if the gas interacts with another species in the sensor that then produces a response.

Generally, an electrochemical sensor includes a sensing electrode (cathode), a reference electrode (anode), and a solid electrolyte provided between the two electrodes. The two electrodes are connected through a potentiometer. Usually, the sensing electrode includes a metal oxide and the reference electrode is a noble metal. These sensors are generally based on measuring the potential difference between the sensing electrode and the reference electrode. The potential difference may be a result of electromotive force (EMF) produced at each of the gas/electrode/solid-electrolyte interface caused by the oxidation and reduction reaction of the metal oxide. The electrochemical sensor of the preferred embodiments is not particularly limited to any design of the sensor. Several different designs of sensors may be used, including, for example, a supported tubular design, a flat plate design, and so forth.

In an exemplary design as illustrated in FIG. 2, an electrochemical sensor may comprise a substrate 22 of a solid electrolyte. The sensor further includes a sensing electrode (cathode) 24 and a reference electrode (anode) 26. As shown, the two electrodes, 24 and 26 are disposed on the same side of the substrate 22, but in some embodiments, the two electrodes may be placed on opposite surfaces of the substrate 22. FIG. 3 illustrates such an embodiment. The sensing electrode 24 is exposed to the exhaust gases. The reference electrode 26 is typically exposed to a known concentration of a gas, for example air (the ambient atmosphere). In some instances, the reference electrode 26 is exposed to the same environment as the sensing electrode 24 or to a different environment, in some other instances. The sensing electrode 24 and the reference electrode 26 are connected through a potentiometer 28.

In addition to the above sensor components, conventional components can be employed, including, but not limited to, leads, contact pads, ground plane(s), support layer(s), additional electrochemical cell(s), insulating layer(s), resistive heating element(s), seal(s), and the like.

In one embodiment, the sensing electrode 24 includes a metal oxide. The metal oxide may be in various states such as a single cation metal oxide or a multi-cation metal oxide. As used herein, the term “multi-cation metal oxide” refers to mixed metal oxide with different oxidation states of the metal. The state of the metal oxide depends on the oxygen partial pressure and temperature. For this reason, metal oxides which are stable in an atmosphere containing oxygen at several hundreds degrees Celsius may be preferred for the sensing electrode. Furthermore, with such sensing electrode, the selectivity of the metal oxide to individual exhaust gases varies with temperature (discussed below).

The metal oxide may include an alkaline-earth metal oxide, a transition metal oxide, a rare earth metal oxide or a combination thereof. Examples of suitable alkaline-earth metal oxides include, but are not limited to, oxides of one or more of magnesium, calcium, strontium, or barium. Non-limiting examples of other suitable metal oxides include oxides of Cr, Ni, Cu, Zn, Nb, Ta, V, Mo, W, Co, Fe, Mn, In, Ga, Sn, Ti, La, Cd, Ce and combinations thereof. In certain embodiments, the metal oxide may include Ni, Cr, Cu, Zn, W, and combinations thereof. In a specific embodiment, the sensing electrode is made of chromium oxide. In another specific embodiment, the sensing electrode is made of nickel oxide. The reference electrode 26 may be composed of a metal that includes one or more elements such as platinum, palladium, ruthenium, rhodium, rhenium, or iridium. In certain embodiments, the reference electrode is composed of platinum, palladium or combinations thereof.

The sensing electrode has a plurality of sintered particles, in some embodiments. The plurality of particles has particle size less than about 8 μm. In certain embodiments, the particles have particle size less than about 1 μm. Furthermore, the sensing electrode, in some embodiments, has a porous structure with a plurality of pores having a pore size less than a selected value. In some embodiments, the selected value is about 5.0 μm; in certain embodiments, the selected value is about 1.5 μm. Not all the pores need to have a pore size less than the selected values, but in some embodiments more than about 50%, and in certain embodiments more than about 60%, of the pores have a pore size less than the selected values. In some embodiments, the electrode structure has a total porosity between about 5 volume percent and about 85 volume percent. In certain embodiments, the porosity is between about 25 volume percent and about 60 volume percent.

In some embodiments, the sensing electrode may form a composite structure with the electrolyte material and in such cases the sensing electrode is also known as a composite sensing electrode. In those instances, the composite sensing electrode contains less than about 75 volume percent of the electrolyte material. In certain embodiments, the composite sensing electrode contains the electrolyte material in an amount ranging from about 33 volume percent to about 67 volume percent. The composite sensing electrode, in some embodiments, has grains of grain sizes less than about 3 μm. In certain embodiments, the grain sizes are less than about 1 μm.

An oxide ion conductor may be applicable as the solid electrolyte to form the substrate 22. The substrate 22 is typically designed as a dense structure such as a plate or a disc. Suitable oxide ion conductors for use in the solid electrolyte of the embodiments may include stabilized zirconia, ceria, a doped ceria, a stabilized bismuth oxide, lanthanum gallate, a doped lanthanum gallate, and combinations thereof. In certain embodiments, the oxide ion conductor is yttria stabilized zirconia (YSZ), or a doped ceria.

The sensing electrode may be coated on the solid electrolyte by using a suitable method and formed by sintering. For example, screen printing, slurry coating, slurry spraying, sol-gel coating, thermal spraying, a physical or chemical vapor deposition method such as vacuum deposition, sputtering, laser ablation, ion beam deposition or ion plating, or chemical deposition method such as a plasma chemical vapour phase deposition, can be used for the formation of the sensing electrode. The electrode formation by these methods can be done of a metal formed beforehand under oxygen or oxygen containing atmosphere or directly by controlling the atmosphere at the formation.

The method of formation of an electrode is not limited to the above-mentioned methods and any method can be used so far as the method can form an electrode composed of the metal oxide or a substance containing these oxides. Furthermore, the reference electrode can be formed by laminated or plugged noble metals like Pt and metals, or by attaching metal mesh to the solid electrolyte.

The first sensor and the second sensor in a sensing component may be the same or different based on material used for sensing electrodes. In one embodiment, the first sensor and the second sensor comprise the same material used for sensing electrodes. In another embodiment, the two sensors are made of substantially different materials.

According to some embodiments of the invention, the first sensor may be disposed to operate at a predetermined temperature T₁. Temperature T₁ is selected in conjunction with the nature of the metal oxide used for the sensing electrode in the first sensor such that the first sensor is selective to a first gas species in presence of a second gas species, for example NO₂ in presence of NO, in one embodiment. In another embodiment, the first sensor is uniquely selective for the first gas species at temperature T₁. A heater may be disposed in thermal communication with the first sensor to heat the first sensor to T₁. In some embodiments, the temperature T₁ varies in the range from about 550 degrees Celsius to about 900 degrees Celsius, and in certain embodiments, from about 650 degrees Celsius to about 800 degrees Celsius.

Selectivity of an individual sensor may be adjusted with temperature. As used herein, the term “selectivity” refers to the degree of specificity of a sensor to a particular target, for example a target gas species in a mixture of two or more gas species. A sensor may be sensitive to various gas species, but may be considered selective for a particular target gas species if the sensitivity of the sensor to the target gas species at a specified composition exceeds the sensitivity to the other gases present in the mixture at specified compositions. Furthermore, a sensor can be considered uniquely selective for a first target gas relative to a second gas if the output of the sensor for a desired composition in a gas stream does not deviate by more than about 10% for a gas stream containing no second gas compared with the output when the second gas at a specified composition is present in the gas stream. In some embodiments the sensor is uniquely selective for a first gas (or “target gas”) in the presence of the second gas (or “interference gas”) when the ratio of the composition of the first gas to the second gas is greater than about 1:1, and in some embodiments, greater than about 1:2. In certain embodiments, the ratio of the composition of the first gas to the second gas is greater than about 1:10. In some embodiments the target gas is NO₂ and the interference gas is NO. In some embodiments the target gas is NO₂ and the interference gas is CO.

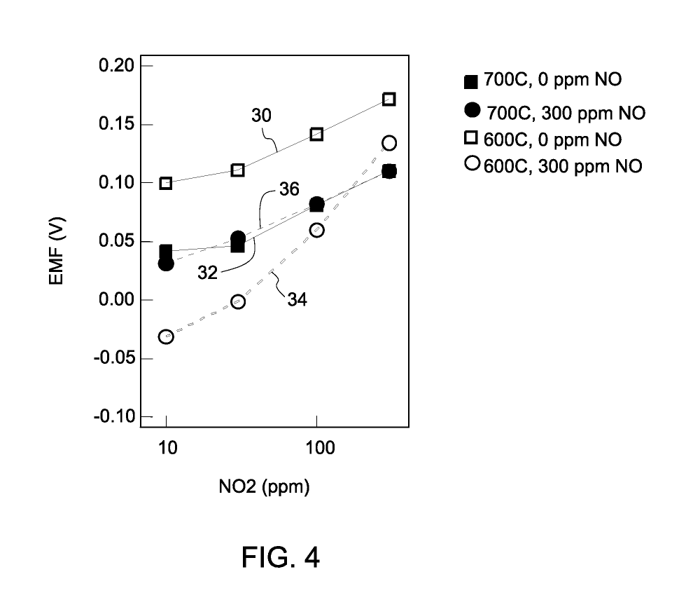

For example, referring to FIG. 4 (discussed in example section) a sensor may be sensitive to NOx gases (NO and NO₂), but the sensitivity may vary with temperature. At higher temperature, the sensor reduces sensitivity for NO and becomes selective for NO₂. At a characteristic temperature, the sensor is uniquely selective for NO₂, and hence is insensitive to NO. Furthermore, selectivity of a sensor at a particular temperature depends on the material used in the sensor, particularly the metal oxide used in the sensing electrode of the sensor.

The second sensor is disposed to operate at a temperature T₂, and at this temperature it is sensitive to the first gas species and the second gas species. In one embodiment, the second gas species is NO. Another heater may be equipped for heating the second sensor, if needed. Temperature T₂ is lower than temperature T₁. In one embodiment, temperature T₂ is at least about 50 degrees Celsius lower than T₁. In some embodiments, temperature T₂ ranges from about 450 degrees Celsius to about 750 degrees Celsius, and in certain embodiments, from about 500 degrees Celsius to about 650 degrees Celsius. In some embodiments, at T₂ the second sensor is sensitive for the first gas species and the second gas species.

With continued reference to FIG. 1, the data analyzer 14 is disposed to receive an output signal from the sensing component 12. The output signal includes individual signals received from each of the sensors of the sensing component. In some embodiments, the output signal comprises two signals: a first signal from the first sensor and a second signal from the second sensor. Each of the first signal and the second signal is a voltage signal. The data analyzer 14 is configured to calculate concentrations of the first gas species and the second gas species based on the output signal from the sensing component. For example, the data analyzer 14 interprets the voltage signals from the first sensor and the second sensor and results in the determination of individual concentrations of NO and NO₂.

Embodiments of the present invention further include a method for calculating concentrations of gas species in combustion gas. Combustion gas contains a gaseous mixture including a first gas species and a second gas species. As discussed in above embodiments, the first sensor is maintained at a temperature T₁ and the second sensor is maintained at a temperature T₂. The sensing component 12 is exposed to the gaseous mixture. Referring to FIG. 1, the first signal and the second signal from the sensing component 12 are transmitted to the data analyzer 14.

The first signal is a unique function of the concentration of the first gas species. The second signal is a unique function of the concentrations of the first gas species and the second gas species. The data analyzer 14 uses an algorithm to simultaneously determine the two unknown gas species from the two known functions of gas concentration at T₁ and T₂.

In one embodiment, the first sensor is uniquely selective, and therefore the first signal is a function of only the concentration of the first gas species. The algorithm is simplified, and can determine the concentration of the first gas species without the need for a second sensor. The second sensor is a function of the first and second gas concentrations. The algorithm can determine the second gas concentration by substituting the first gas species concentration into the function of the second sensor.

For example, assume the detection system is exposed to combustion gas containing a mixture of NO and NO₂ gases. The first sensor, at a higher temperature, is uniquely selective to NO₂ gas and hence the first signal from the first sensor is determined substantially solely by the concentration of NO₂. At a lower temperature, the second sensor provides the second signal determined by combination of concentrations of NO and NO₂. The concentration of NO₂ is determined uniquely from the first signal and the second signal provides an equation with two unknowns. An algorithm is programmed in such a way to automatically determine NO concentration from the second signal by using concentration of NO₂ from the first signal. Thus, the concentrations of NO and NO₂ can be uniquely determined.

The disclosed detection system and method provide an approach for simultaneously and interdependently determining individual concentrations of gas species in a mixture of gases, for example in a combustion chamber. The detection system described herein operates without the need for a conditioned gas, in contrast to conventional sensors. In addition, the current method is operational at temperatures above 600° C., which is advantageous for faster response with change in gas concentrations.

Though the embodiments of the present invention provide examples in the context of measuring NO and NO₂ concentrations, the method can be applied for measuring concentrations of multiple gases, for example NO, NO₂, CO and CO₂, by utilizing multiple sensors, where the sensors have different selectivities at different temperatures and, possibly, due in part to different compositions. In one embodiment, the sensing component 12 further includes at least one additional sensor. The additional sensor is disposed to allow operation at a temperature T₃ at which the additional sensor is selective to at least two gas species.

In some embodiments, an oxygen sensor may be used to determine the oxygen concentration within the sensing component 12. The oxygen sensor response may also provide a signal to the data analyzer 14. The algorithm would then be able to use the signal to determine the specific transfer functions needed for the first sensor and the second sensor, if the transfer functions are dependent on oxygen concentration.

### EXAMPLES

The examples that follow are merely illustrative, and should not be construed to be any sort of limitation on the scope of the claimed invention.

### Example 1

Yttria stabilized zirconia (YSZ) was used as solid electrolyte to form a disc shaped substrate. A reference electrode was formed by attaching platinum mesh to one surface of the YSZ disc with platinum paste and subsequent high temperature firing. A sensing electrode was formed by depositing a Chromium oxide slurry coating to the other surface of the YSZ disc, with embedded platinum mesh, and sintering at high temperature. The platinum mesh was used to function as an electron collector. The structure/configuration of the sensor is shown in FIG. 3. The reference electrode was sealed and exposed to air. The sensor was tested with the sensing electrode exposed to a simulated combustion environment comprising 3% O₂, 14% CO₂, 10% H₂O, ppm levels of NO₂ and NO, and remaining balance of N₂. The open circuit electromotive force (EMF) output of the sensor was plotted as a function of increasing NO₂ concentration from 10 ppm to 300 ppm, at different temperatures in absence and in presence of NO. FIG. 4 shows such plots. Plots 30 and 32 represent increasing NO₂ concentration without NO (i.e. 0 ppm NO) at 600 degrees Celsius and 700 degrees Celsius, respectively. Furthermore, plots 34 and 36 represent increasing NO₂ concentration for a fixed NO concentration of 300 ppm, at 600 degrees Celsius and 700 degrees Celsius, respectively. At 700 degrees Celsius, the EMF response with change in NO₂ concentration was unaffected by the presence of 300 ppm of NO, and was therefore uniquely selective for NO₂. However at 600 degrees Celsius, there was substantial reduction in EMF in the presence of NO. As the NO2 concentration was varied from 10 ppm to 300 ppm, holding the NO concentration at 300 ppm, the EMF varied from about −30 mV to 135 mV. At 600 degrees Celsius, the sensor was not selective for NO₂. These data showed that a sensor might have distinctly different responses to the same gas at different temperatures.

### Example 2

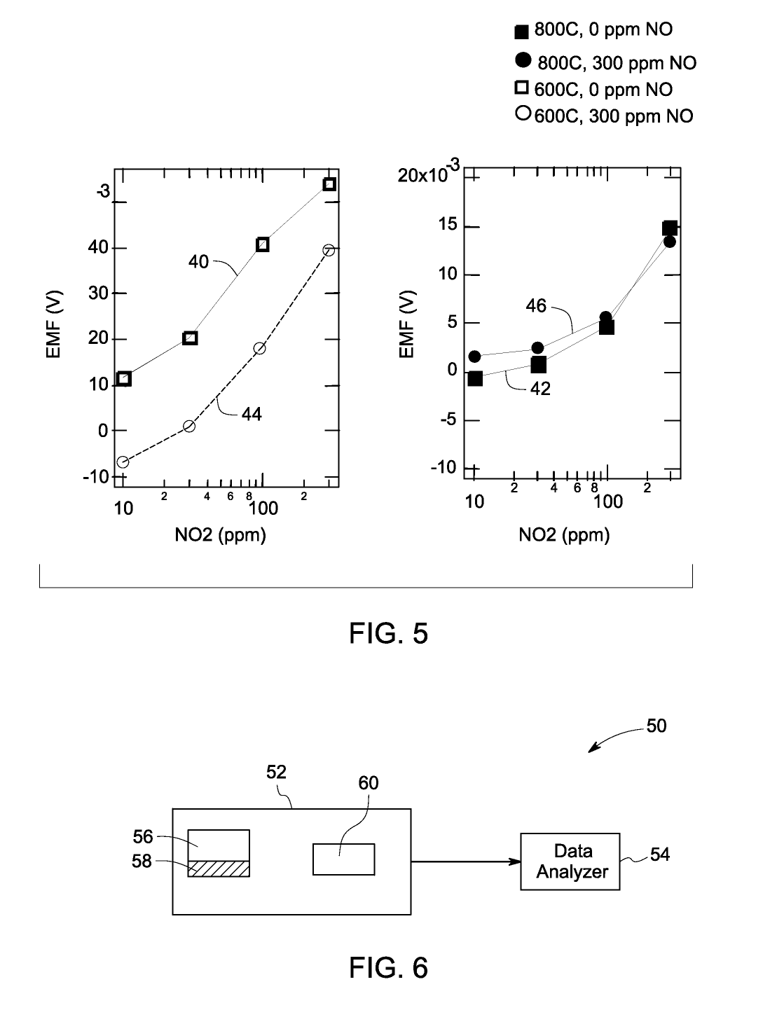

Yttria stabilized zirconia (YSZ) was used as solid electrolyte to form a disc shaped substrate. A sensing electrode was formed by depositing a nickel oxide slurry coating to the surface of the YSZ disc, with embedded platinum mesh, and sintering at high temperature. The platinum mesh was used to function as an electron collector. A reference electrode was formed by attaching platinum mesh to the same surface of the YSZ disc with platinum slurry, followed by a subsequent high temperature firing. The structure/configuration of the sensor is shown in FIG. 2. The sensor was tested with the sensing electrode and the reference electrode exposed to a simulated combustion environment comprising 3% O₂, 14% CO₂, 10% H₂O, ppm levels of NO₂ and NO and remaining balance of N₂. The open circuit electromotive force (EMF) output of the sensor was plotted as a function of increasing NO₂ concentration from 10 ppm to 300 ppm, at different temperatures in absence and in presence of NO. FIG. 5 shows such plots. Plots 40 and 42 represent increasing NO₂ concentration at 600 degrees Celsius in absence of NO (i.e. 0 ppm NO) and in presence of 300 ppm of NO, respectively. Furthermore, plots 44 and 46 represent increasing NO₂ concentration in absence of NO (i.e. 0 ppm NO) and in presence of 300 ppm of NO at 800 degrees Celsius, respectively. At 800 degrees Celsius, the EMF response with change in NO₂ concentration was unaffected by the presence of 300 ppm of NO, and was therefore highly selective for NO₂. The voltage increased from 0 to 15 mV when increasing from 10 to 300 ppm of NO₂, regardless of NO concentration. However at 600 degrees Celsius, there was substantial reduction in EMF in the presence of NO. As the NO₂ concentration was varied from 10 ppm to 300 ppm at 600° C., holding the NO concentration at 300 ppm, the EMF varied from about −5 mV to 40 mV. However, without NO, varying NO₂ from 10 to 300 ppm resulted in a voltage response of 10 to 50 mV, respectively. Therefore, at 600 degrees Celsius, the sensor was not selective for NO₂.

### Example 3

The above data from Example 1 and Example 2 can be used to determine individual concentrations of NO and NO₂ gases in NOx containing gaseous mixture by using a detection system having two sensors as described below.

A detection system 50 has a sensing component 52 and a data analyzer 54 is shown in FIG. 6. The sensing component 52 has two sensors of the same material as described in example 1. A first sensor 56 is at temperature 700 degrees Celsius and hence, is selective for NO₂. The first sensor 56 may be heated by using a heater 58. The second sensor 60 is at a temperature lower than 700 degrees Celsius and is selective for both, NO and NO₂. The data analyzer 54 receives an output signal from the sensing component 52, the output signal contains a first voltage signal V₁ from 56 and a second voltage signal V₂ from 60. The voltage signal V₁ is a function of concentration of NO₂ only and the voltage signal V₂ is a function of concentrations of both NO and NO₂. Thus, the data analyzer has two equations corresponding to two signals, V₁ and V₂, with two unknowns (concentrations of NO and NO₂). The data analyzer is configured/programmed to automatically simultaneously solve the two equations to calculate the concentrations of NO and NO₂.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A detection system comprising:
a sensing component comprising a first sensor, and a second sensor in fluid communication with the first sensor, wherein the first sensor is disposed to allow operation at a predetermined temperature T₁ at which the first sensor is selective to a first gas species in the presence of a second gas species, and the second sensor is disposed to allow operation at a temperature T₂, where T₂ is lower than T₁, and wherein the second sensor is sensitive for the first gas species and the second gas species at T₂; and
a data analyzer disposed to receive an output signal from the sensing component and configured to calculate concentrations of the first gas species and the second gas species based on the output signal from the sensing component.

2. The detection system of claim 1, wherein each of the first sensor and the second sensor is an electrochemical gas sensor.

3. The detection system of claim 2, wherein each of the first sensor and the second sensor comprises a sensing electrode, a reference electrode, and an electrolyte that connects the sensing electrode and the reference electrode.

4. The detection system of claim 3, wherein the sensing electrode comprises a metal oxide.

5. The detection system of claim 4, wherein the metal oxide comprises a single cation metal oxide or a multi-cation metal oxide.

6. The detection system of claim 5, wherein the metal oxide comprises an alkaline-earth metal oxide, a transition metal oxide, a rare earth metal oxide or a combination thereof.

7. The detection system of claim 6, wherein the metal oxide comprises at least one element selected from the group consisting of Cr, Ni, Cu, Zn, Nb, Ta, V, Mo, W, Co, Fe, Mn, In, Ga, Sn, Ti, La, Cd, Ce and combinations thereof.

8. The detection system of claim 4, wherein the sensing electrode comprises chromium oxide.

9. The detection system of claim 4, wherein the sensing electrode comprises nickel oxide.

10. The detection system of claim 3, wherein the reference electrode comprises a metal selected from the group consisting of platinum, palladium, ruthenium, rhodium, rhenium, and iridium.

11. The detection system of claim 3, wherein the reference electrode is exposed to air.

12. The detection system of claim 3, wherein the reference electrode is disposed to be exposed to same environment as the sensing electrode.

13. The detection system of claim 3, wherein the electrolyte comprises at least one oxide ion conductor selected from the group consisting of stabilized zirconia, ceria, a doped ceria, a stabilized bismuth oxide, lanthanum gallate, a doped lanthanum gallate, and combinations thereof.

14. The detection system of claim 1, wherein the first sensor is uniquely selective for the first gas species at T₁.

15. The detection system of claim 1, wherein T₁ is in the range from about 550 degrees Celsius to about 900 degrees Celsius.

16. The detection system of claim 1, wherein T₁ is in the range from about 650 degrees Celsius to about 800 degrees Celsius.

17. The detection system of claim 1, wherein T₂ is in the range from about 450 degrees Celsius to about 750 degrees Celsius.

18. The detection system of claim 1, wherein T₂ is in the range from about 500 degrees Celsius to about 650 degrees Celsius.

19. The detection system of claim 1, wherein T₁ is at least about 50 degrees Celsius higher than T₂.

20. The detection system of claim 1, wherein the output signal comprises two signals: a first signal from the first sensor and a second signal from the second sensor.

21. The detection system of claim 20, wherein each of the first signal and the second signal are voltage signals.

22. The method of claim 20, wherein the first signal is a function of the concentration of the first gas species and the second signal is a function of the concentrations of the first gas species and the second gas species.

23. The detection system of claim 1, wherein the first gas species comprises NO₂.

24. The detection system of claim 1, wherein the second gas species comprises NO.

25. The detection system of claim 1, wherein the sensing component further comprises at least one additional sensor.

26. A detection system comprising:
a sensing component comprising a first sensor, and a second sensor in fluid communication with the first sensor, wherein the first sensor is disposed to allow operation at a predetermined temperature T₁ at which the first sensor is uniquely selective to a first gas species in the presence of a second gas species, and the second sensor is disposed to allow operation at a temperature T₂, where T₂ is lower than T₁, and wherein the second sensor is sensitive for the first gas species and the second gas species at T₂; and
a data analyzer disposed to receive an output signal from the sensing component and configured to calculate concentrations of the first gas species and the second gas species based on the output signal from the sensing component.

27. A method for calculating concentrations of gas species in combustion gas, the method comprising the steps of:
providing a detection system comprising a sensing component, the sensing component comprising a first sensor and a second sensor;
exposing the first and second sensor to a gaseous mixture comprising a first gas species and a second gas species;
maintaining the first sensor at a temperature T₁ at which the first sensor is selective to the first gas species;
maintaining the second sensor at a temperature T₂ wherein T₂ is lower than T₁ and wherein at T₂ the second sensor is selective to the first gas species and the second gas species;
transmitting an output signal from the sensing component to a data analyzer; and
calculating the concentrations of the first gas species and the second gas species based on the output signal.

28. The method of claim 27, wherein calculating comprises translating the first signal and the second signal to an algorithm and solving the algorithm to find out concentrations of the first gas species and the second gas species.
